(19) United States
(12) Patent Application Publication
(10) Pub. No.: US 2007/0167337 A1
(43) Pub. Date: Jul. 19, 2007

(54) Method of treatment of a surface

(75) Inventors: Victoria Heather Cobb, Hull (GB); Andrea Duddington, Hull (GB); Coreen Iligge, Hull (GB); Ian Gordon Jolliffe, Hull (GB)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (UK) LIMITED, Slough, Berkshire (GB)

(21) Appl. No.: 10/598,235

(22) PCT Filed: Feb. 8, 2005
(86) PCT No.: PCT/GB05/00428

§ 371 Date: Aug. 22, 2006

(30) Foreign Application Priority Data
Feb. 27, 2004 (GB) 0404326.1

(51) Int. Cl. C11D 3/02; C11D 7/50

(52) U.S. Cl. 510/108; 510/461

(57) ABSTRACT

Kits, applicators and methods for treatment of a surface involve sequential application to a surface of a hydrogel precursor and a crosslinking component to form a removable hydrogel patch on the surface followed by removal of the patch. The method is suitable for removal of a stain from a surface.

This is an application filed under 35 USC 371 of PCT/GB2005/000428.

The present invention relates to a method for the treatment of a surface, particularly a textile surface, and more particularly to a method for the treatment of a surface such that a stain is removed, or at least partially removed. The present invention also relates to products for use in such methods.

It is well-known to treat textiles such as clothing, carpets, mats, upholstery, fabrics, wall-coverings, and the like in various ways. For instance, it is possible to treat textiles to impart a fragrance thereto, to condition them (for example, by the use of anti-static agents, and the like), or to cleanse them (by the use of powder or liquid detergent compositions, and the like).

Conventionally, in order to perform the task of washing textiles, that is, in order to remove common stains and the like, some water and a washing machine is required to complete the washing task. Moreover, the task can take several hours to complete, including the drying process. In addition, this conventional process will wash the whole garment or article, and in the case of a spot stain, this is clearly not necessarily required. In effect, the conventional washing/drying process is both time-consuming and wasteful of resources if all that is required is treatment of a spot stain. Conventional dry cleaning processes have similar drawbacks.

A further disadvantage in using conventional washing processes when treating spot stains is that it is not always possible or convenient to treat the spot stain immediately, for instance if the required conventional washing equipment is not to hand. It is also known that in general, the quicker a stain is treated, such as a spot stain, the better the chance of successful removal. Moreover, it is often most convenient to deal with a spot stain as soon as it occurs such that one can perhaps avoid the need of washing the textile at all using conventional processes, or the spot stain can be removed or at least partially removed, such that effect of any unsightly stain is reduced to a level that allows the reduced stain to be tolerated, perhaps until conventional washing processes, or dry cleaning processes, can be employed.

Therefore, there is the need to provide convenient stain removing or partially removing (i.e. stain reducing) patches which seek to alleviate the above-mentioned drawbacks of conventional washing processes, and/or provide convenient methods of stain removal/reduction, such as stain removal/reduction without the need for a full conventional washing process. Moreover, there is the need to provide stain removing/reducing patches which improve the effectiveness of the conventional washing or dry cleaning processes.

WO-A-02/102957 (to Reckitt Benckiser (UK) Limited) discloses textile treatment compositions comprising a patch with a water impervious backing made of a polymer sheet to which is attached a hydrogel containing a surfactant treatment fluid.

Nevertheless, there remains the need for alternative and/or improved methods for the treatment of surfaces, particularly textile surfaces, for the removal/reduction of stains, both in terms of user convenience and stain removal/reduction ability, and for alternative and/or improved surface, particularly textile surface, treatment compositions.

Therefore, in a first aspect, the present invention provides a method for the treatment of a surface comprising the sequential application to the surface of a hydrogel-precursor component and a crosslinking component, in either order, to form a removable hydrogel patch on said surface, and the removal of the patch once the removable hydrogel patch has formed or substantially formed thereon.

Thus, in the method of the invention, the hydrogel-precursor and crosslinking components are kept separate from each other until they are sequentially applied to the surface.

By “sequential”, we mean that the second (and further, if present) component is applied to the surface after the first (or previous) component has been applied, more preferably with a time gap between such applications, as described hereinafter.

Preferably, the method is such that it can conveniently be carried out in circumstances where there is no availability of conventional washing processes, or where such conventional processes would be inconvenient, for instance where the user wishes to treat a spot stain immediately, for instance as and when staining occurs. In such cases, it may not be necessary to clean the whole surface and the present method enables just the area of the surface stained to be treated.

Moreover, although the removal of the removable patch is generally performed manually by the user, for example by peeling, it is also possible for the removable patch, once formed, to be removed as part of the conventional washing or dry cleaning process, such as in a textile washing machine. In such cases, the removable patch comprises a water-soluble or dispersible polymer which dissolves or disperses into a wash liquor. Thus, one benefit of the method of the invention is that it is possible for the user to control the formation of the removable patch as soon as possible after the staining has occurred and the conventional washing/dry cleaning process can then be carried out at a convenient time thereafter. Conventional wash pre-treatments essentially require the washing/dry cleaning process to follow almost immediately after application of the pre-treatment formulation, i.e. whilst the pre-treatment is still wet. Hence, the present method enables the treating effect of the removable patch to be started as soon as practical after staining, with the washing/dry cleaning process following at a convenient time thereafter.

The hydrogel-precursor and crosslinking components are components comprising respectively a hydrogel-precursor and a crosslinker capable of crosslinking the hydrogel-precursor to form a hydrogel patch. Preferably the two components are both liquids. By liquid it is meant that they have a viscosity of 100,000 mPa·s or less at a shear rate of 1s⁻¹ measured at 25° C.

Suitably, the method of the invention enables the user to more precisely determine the onset of the formation of the patch, by the sequential addition of the two components, particularly as the two components are preferably such that patch formation requires the presence of both or the at least two components. As such, the user can either speed up the onset of patch formation by adding the at least two components in fairly quick succession, and thus quicken the overall treatment method, or the user can delay the onset of the patch formation by leaving a longer time delay before adding the second component, and thus slow down the overall treatment method, giving further time for the still liquid first component to penetrate into the textile. As the removal/reduction of a stain will be enhanced by at least part of the stain passing into the liquid components and then being “locked” into the patch as it forms, delaying the onset of patch formation can be advantageous.

Preferably, by “treatment” we mean cleaning, more preferably stain removal or reduction.

By “removable patch” we mean a patch that has sufficient solid or gel-like characteristics that it is peelable or otherwise substantially removable by the user without the user requiring any specialist techniques or aids, or which is removed by conventional washing or dry cleaning processes after becoming solid or substantially solid or gel-like.

By “surface”, we include both hard and soft surfaces. By “hard surface”, we include ceramics, glass, stone, plastics, marble, metal and/or wood surfaces, such as, in the household environment for example, bathroom and kitchen hard surfaces such as sinks, bowls, toilets, panels, tiles, worktops, dishes, and the like. Hard surfaces are non-porous to water, by which it is meant that a hard surface, on contact with water for 5 minutes, takes up less than 5 mg of water per cm².

By “soft surface”, we include textiles, clothing, carpets, curtains, upholstery, textile or fabric covered articles, and the like. Soft surfaces are porous to water, by which it is meant that a hard surface, on contact with water for 5 minutes, takes up 5 mg or of water per cm².

Thus, there is provided a method of spot stain removal/reduction, which is convenient, practical, can be performed in situ (i.e. by the user immediately after the stain is noted), available wherever the user is situated, and employable without necessarily requiring conventional washing means, or a method which improves the effectiveness of the eventual washing process. In essence, the user is in control of the formation of the patch and can thus conveniently apply removable-patch forming components at his convenience. A yet further advantage is that the user is able to visibly see the stain passing into the removable patch as it forms and once removed, the patch may show some colouration from the stain, confirming to the user the effectiveness of the method. A still yet further advantage of the present invention is that the user can control the onset of patch formation by the timing of the sequential addition of the components. A yet further advantage is that no pre-mixing of the components is required.

The crosslinking component cross-links the hydrogel-precursor polymeric material of the hydrogel-precursor component as part of the patch-forming process, leading to the formation of a hydrogel patch. Therefore, a requirement for this crosslinking component is that it comprises a species capable of cross-linking the polymer material of the other component as part of the patch-forming process.

By the term “hydrogel” as used herein it is meant a natural or synthetic polymeric material which possesses the ability to swell in water. The hydrogel may be water-insoluble or water-soluble; preferably it has a solubility in water of less than 1 g/dm³. By “hydrogel-precursor” is meant a material which can be cross-linked in order to form a hydrogel. Natural hydrogel precursors are suitable for the invention, such as alginates and other polysaccharides with free carboxylic acid groups.

Suitably, the hydrogel-precursor is a hydrophilic homopolymer or copolymer of acrylic or methacrylic acid, or a salt thereof; or a carboxylated cellulose derivative. The polymer, once formed into a hydrogel, is cross-linked to a relatively low degree and but for the cross-linking would be essentially water-soluble.

The polymer may include in its structure a polysaccharide such as starch, for example in a graft copolymer.

Where the hydrogel-precurser comprises free carboxylate groups as described above, the crosslinking component suitably comprises metal M²⁺ ions (where M is a Group IIA element or any other metallic element capable of exhibiting a +2 oxidation state), more preferably wherein M is a Group IIA element, even more preferably Ca²⁺ ions, i.e. this liquid component comprises an M²⁺ salt, e.g. a calcium salt. Yet more preferably, this liquid component comprises Ca²⁺ ions in the form of calcium chloride.

In another embodiment, the hydrogel precursor may be carrageenen, preferably iota-carrageenan, or pectin. For these materials, calcium ions are suitable crosslinking agents. Another suitable hydrogel precursor is chitosan, which is soluble in acidic or protonated form, and gels in the presence of alkali. If the hydrogel-precursor component comprises chitosan, the crosslinking component should comprise an alkali, preferably sodium hydroxide.

More preferably, the hydrogel-precursor comprises alginic acid or an alginate, where an alginate is a salt of alginic acid, even more preferably, a sodium alginate. Hereinafter, the term “alginate” is used to refer to either alginic acid or a water-soluble salt thereof, such as a sodium salt.

Alginic acid or alginates may be found in and isolated from various organisms, in particular from algae belonging to the order Phaeophyceae and soil bacteria such as Azotobacter vinelandii and Azotobacter crococcum and from several strains of Pseudomonas bacteria. Common algal sources of algins include Laminaria digitata, Ecklonia maxima, Macrocystis pyrifera, Lessonia nigrescens, Ascophyllum nodosum, Laminaria japonica, Durvillea antartica, Durvillea potatorum and, especially, Laminaria hyperborea.

Alginic acid is a linear hetero-polysaccharide comprising units of β-D-mannuronic acid and α-L-guluronic acid. Alginic acid may comprise homopolymeric sequences of mannuronic acid, homopolymeric sequences of guluronic acid, and mixed sequences of mannuronic acid and guluronic acid units.

Salts of alginic acid used in the method of the present invention may include alkali metal salts, for example sodium and potassium salts, and ammonium and alkanolamine salts. Alkali metal salts are of particular interest.

The terms “algins” or “alginates” as used herein include alginic acid and salts of alginic acid, irrespective of the relative proportion of mannuronic and guluronic units, and is intended to include glycolated or alkoxylated derivatives, especially those derivatised with propylene glycol. However, preferred compounds are not alkoxylated or glycolated. Guluronic acid-rich alginic acid and guluronic acid-rich salts of alginic acid are of particular interest. Preferred compounds have at least 50%, more preferably 55-99%, most preferably 60-80% of guluronic units (by weight of the polymer), the balance being mannuronic units. For guidance on production of algins very high in guluronic units the reader is referred to WO 98/51710.

The crosslinking and hydrogel-precursor components may be applied sequentially in either order: crossliking component first or hydrogel-precursor component first. However it is preferred that the first component applied to the surface is the crosslinking component and the second liquid component to be added is the hydrogel-precursor component.

In the above-mentioned embodiments, the method of the invention results in the formation of a gel-like patch which, after a suitable time period, can be removed by the user from the surface to which the components have been sequentially applied. Clearly, the easier the patch is to remove from the surface, the more user-friendly and effective will be the method of the invention. It has been found that sequential addition of a third component, i.e. a treatment method comprising the steps of the sequential addition of three liquid components to form a removable patch, and the removal of the patch once the said removable patch has formed or substantially formed, is preferred when the third component acts as a hardener or setting agent and as such, decreases the time for the patch to form or to substantially form. In this preferred embodiment, the first liquid component is preferably the crosslinking component and is also found to be a preferred third component. Hence, in this preferred embodiment, the sequential addition of components is as follows: first component, crosslinking component; second component, hydrogel-precursor component, as hereinbefore defined; third component as first component (as hereinbefore defined).

Even more preferably, the first component comprises CaCl₂, the second component comprises an alginate, preferably a sodium alginate, the third component comprises CaCl₂.

However, although a decrease in the time taken to form or substantially form the removable patch can in some instances be preferred, particularly from the point of view of convenience and hence user-compliance, in other instances where the stain removal is taking place whilst the patch forms, an increase in the time taken for the patch to form can be an advantage. In effect, there is a balance between the shorter times preferred for user-friendliness and convenience, and the slightly longer times preferred to enable more of the stain to be taken out of the surface (by wicking, capillary action, or diffusion into the components, as the removable patch forms from the liquid components). Preferably, a removable patch is formed or substantially formed between 30 secs and 15 mins after the final component is applied, more preferably between 45 secs and 12 mins after the final component is applied, most preferably between 1 min and 10 mins after the final component is applied.

Preferably, the cross-linking component comprises M²⁺, ions, preferably Ca²⁺ ions in the range 0.03 to 5 wt % of the overall weight of this component, more preferably in the range 0.05 to 4 wt %, even more preferably in the range 0.1 to 3 wt %, most preferably in the range 0.2 to 2 wt %.

When the metal ion is provided by calcium chloride, the preferred weight percentage expressed as weight percent of CaCl₂.2H₂O in the crosslinking component is 0.1 to 20 wt % of the overall weight of this component, more preferably 0.6 to 19 wt %, even more preferably 0.8 to 17 wt %, most preferably 1 to 16 wt %.

Preferably, the hydrogel-precursor component, more preferably comprising an alginate, comprises hydrogel-precursor in the range 0.1 to 10 wt % compared to the overall weight of that component, more preferably in the range 0.25 to 5 wt %, most preferably 0.4 to 4 wt %, for example 0.5 wt % to 3 wt %. More preferably, when alginate is used, the alginate should have a G-block content of at least 15% of the total polymer weight, even more preferably at least 25%, most preferably at least 35%, as this is found to increase the integrity of the patch thus formed and hence the ease with which the removable patch thus formed can be removed. More preferably the alginates have at least 50%, even more preferably 55-99%, most preferably 60-80% of guluronic units (by weight), the balance being mannuronic units.

Without wishing to be bound by theory, alginates are, as noted hereinbefore, comprised of mannuronate and guluronate monomers and in order to form a gel, and thus a usable patch in the method of the present invention, the alginate should contain a sufficient level of guluronate monomers in a block to react with the metal cations, such as divalent ions, from the other component(s) to form a gel. It is believed that the divalent ions especially, essentially “fit” into the guluronate block structure in suitable alginates.

Suitable alginates for use in the method of the present invention include those in the Protanal™ range, LF20™, GP6650™, and XP3499™ (all available from FMC BioPolymer of Philadelphia, Pa. 19103, USA). Protanal™ LF20™ is preferred and is a sodium alginate available from FMC BioPolymer. A 1 wt % aqueous solution thereof at ambient temperature of 25° C. has a viscosity of 155 to 255 mPa·s at a shear rate of 1 s⁻¹ and a pH of 6.0 to 8.0.

Preferably, all components used in the method of the present invention are liquid solutions, more preferably aqueous solutions (i.e. free-flowing aqueous solutions).

In further embodiments of the invention further agents or moieties can be in one, more, or all of the components of the method of the invention, as described below, which may improve still further the treatment ability of the method of the invention.

For the avoidance of doubt, any one or more of these agents can be added to the components as set out hereinafter, in any mutually compatible manner.

Hence, a yet further advantage of the method of the present invention is that because the at least two components are kept separate as and until the user wishes to form the patch, it is possible for mutually incompatible or antagonistic further ingredients or agents to also be effectively kept apart, as and until the removable patch is to be formed.

Silicones

It is preferred if at least one of the two components of the method of the invention comprises a silicone oil, preferably a cyclic or linear polydimethylsiloxane preferably having a viscosity at 25° C. and a shear rate of 1 sec⁻¹ of from 10 to 10,000 mPa·s.

Such silicone oil is suitably in the form of emulsified droplets, preferably in the hydrogel-precursor component of the invention. A suitable level is from 0.1 to 2%, preferably from 0.5 to 1.5% by weight of the hydrogel patch formed in the method. Suitable surfactants for use in emulsification may be as described below. Alternatively, a silicone-based surfactant may be used.

The advantage of the presence of the silicone oil in the components used in the method of the invention is that it provides improved peelability for the hydrogel patch.

Anti-Limescale Agents

Examples of anti-limescale agents include acids, particularly organic acids (e.g. citric acid), and anti-nucleating polymers, such as polyacrylates. Other relevant acids that may be present include glycolic and sulphamic acids. Preferably, the amount of acid present for limescale removal is sufficient to provide an overall pH of the patch of 1-7, more preferably 2-7, most preferably 3-6.

Bleach

Peroxygen bleaching agents are preferred. Suitable peroxygen bleaching compounds include sodium carbonate peroxyhydrate and equivalent “percarbonate” bleaches, sodium pyrophosphate peroxyhydrate, urea peroxyhydrate, and sodium peroxide. Persulfate bleach (e.g. OXONE, manufactured commercially by DuPont) can also be used. Perestane or PAP are also suitable bleaches for use with the invention.

Bleach activators can also be present. Bleach activators lead to the in situ production in aqueous solution of the peroxy acid corresponding to the bleach activator. Various nonlimiting examples of activators are disclosed in U.S. Pat. No. 4,915,854, issued Apr. 10, 1990 to Mao et al, and U.S. Pat. No. 4,412,934. The nonanoyloxybenzene sulfonate (NOBS) and tetraacetylethylene diamine (TAED) activators are typical and are preferred, and mixtures thereof can also be used. See also U.S. Pat. No. 4,634,551 for other typical bleaches and activators useful herein.

The bleach system if present, may be in the cross-linking component.

More preferably, the bleach system is contained in the component containing the hydrogel-precursor. It has been found that this gives improved stain removal from soft surfaces compared to having the bleach in with the other component.

The bleach is present at a level in the range 0 to 8 wt %, more preferably 1 to 7 wt %, most preferably in the range 2 to 6 wt %, of the component in which it is situated.

In embodiments of the invention where a peroxide or peroxide generator is used as a bleach system, it is preferred if the peroxide or peroxide generator is present in the hydrogel-precursor component at a pH from 4 to 6, preferably 4.5 to 5.5. At lower pH the precursor may be unstable. At higher pH the peroxide may dissociate on storage.

In such embodiments, it is preferred if the pH of the other, cross-linking component is 8 to 10, preferably 8.5 to 9.5. This helps to increase the effectiveness of the peroxide for bleaching when the components are mixed. If the pH of the metal ion-containing component is too high, the ions may precipitate from solution, especially where Ca²⁺ ions are present.

Enzymes

Enzymes can be included in the components herein for a wide variety of fabric laundering purposes, including removal of protein-based, carbohydrate-based, or triglyceride-based stains, for example, and for the prevention of dye transfer, and for fabric restoration. The enzymes to be incorporated include proteases, amylases, lipases, cellulases, and peroxidases, as well as mixtures thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, builders and so on. In this respect bacterial or fungal enzymes are preferred, such as bacterial amylases and proteases, and fungal cellulases.

Preferably, enzymes if present, are in any component, at a level in the range 0.001 to 5 wt %, more preferably 0.01 to 1 wt %, of the component.

Solvent

Solvents, particularly organic solvents, may be present in any of the components. More preferably, organic solvents, such as glycol ethers, C₁-C₁₀ alcohols, C₁-C₁₀ hydrocarbons or halohydrocarbons, carbonyl-based solvents such as acetone, and the like, are present, preferably in the component(s) comprising M²⁺ ions. The organic solvent, if present, should preferably be included in an amount from 5 to 50 wt % of the component. The overall levels of organic solvents should be within the VOC limits of cleaning products and preferably, the maximum level of organic solvent in each component is 8 wt %, more preferably, up to 6 wt %, most preferably up to 4 wt %.

Surfactant

Non-limiting examples of surfactants useful herein comprise an anionic such as sulfonates, sulphates and ether sulphates or/and a nonionic such as a ethoxy or propoxylated alkyl, fatty acid or alcohol. These include the conventional C11-C18 alkyl benzene sulfonates (“LAS”) and primary, branched-chain and random C10-C20 alkyl sulfates (“AS”), the C10-C18 secondary (2,3) alkyl sulfates of the formula CH₃(CH₂)ₓ(CHOSO₃-M⁺)CH₃ and CH₃(CH₂)_{y}(CHOSO₃-M⁺)CH₂CH₃ where x and (y+1) are integers of at least about 7, preferably at least about 9, and M is a water-solubilising cation, especially sodium, unsaturated sulfates such as oleyl sulfate, the C10-C18 alkyl alkoxy sulfates (“AExS”; especially EO 1-7 ethoxy sulfates). C10-C18 alkyl alkoxy carboxylates (especially the EO₁₋₅ ethoxycarboxylates), the C10-18 glycerol ethers, the C10-C18 alkylpolyglycosides and their corresponding sulfated polyglycosides, and C12-C18 alpha-sulfonated fatty acid esters. If desired, the conventional nonionic and amphoteric surfactants such as the C12-C18 alkyl ethyoxylates (“AE”) including the so-called narrow peaked alkyl ethoxylates and C6-C12 alkyl phenol alkoxylates (especially ethyoxylates and mixed ethoxy/propoxy), C12-C18 betaines and sulfobetaines (“sultaines”), C10-C18 amine oxides, and the like, can also be included in the overall compositions. The C10-C18 N-alkyl polyhydroxy fatty acid amides can also be used. Typical examples include the C12-C18 N-methylglucamides. See WO 92/06154. Other sugar-derived surfactants include the N-alkoxy polyhydroxy fatty acid amides, such as C10-C18 N-(3-methoxypropyl) glucamide. Mixtures of anionic and nonionic surfactants are especially useful. Other conventional useful anionic, amphoteric, nonionic or cationic surfactants are listed in standard texts.

Preferably, the surfactant is sodium lauroyl sarcosinate, available in 30% form as SURFAC SL30F™ (from Surfachem Plc, Leeds LS14LT, UK). More preferably, Sodium lauryl sulphate is employed as the surfactant. Preferably, surfactant(s) if present, is/are in the hydrogel-precursor component, at a level in the range 0.01 to 50 wt %, more preferably 0.05 to 20 wt %, most preferably 0.1 to 10 wt %, for example 4 wt %, of the component.

Anionic surfactants are preferred over nonionic or zwitterionic surfactants, in that they give improved peelability of the formed hydrogel patch.

Preferably, at least one of the components used in the method of the invention further includes one or more of the following: a bleach (with or without a bleach activator), an enzyme or enzyme system (including any necessary stabilisers) and at least one surfactant, more preferably at least one surfactant. In this particular embodiment, i.e. when the method is essentially an enhanced cleaning method (due to the presence of the bleach/enzyme/surfactant agent(s)), any or all of the components may further comprise fragrances. Preferred fragrances which can be included in the components herein include but are not limited to those selected from the group consisting of aromatic and aliphatic esters, for example those esters having molecular weights of from 100 to 300, preferably 130 to 250; aliphatic and aromatic alcohols, for example those having molecular weights of from 75 to 250, preferably 90 to 240; aliphatic ketones, for example those having molecular weights of from 100 to 300, preferably 150 to 260; aromatic ketones, for example those having molecular weights of from 100 to 300, preferably 150 to 270; aromatic and aliphatic lactones, for example those having molecular weights of from 100 to 350, preferably 130 to 290; aliphatic aldehydes, for example those having molecular weights of from 100 to 250, preferably 140 to 200; aromatic aldehydes, for example those having molecular weights from 50 to 250, preferably 90 to 230; aliphatic and aromatic ethers, for example those having molecular weights of from 100 to 300, preferably 150 to 270; and condensation products of aldehydes and amines, for example those having molecular weights of from 100 to 400, preferably 180 to 320.

Preferably, if present in the components used in the enhanced cleaning methods of this embodiment of the invention, fragrance is in either component at a level in the range of 0.1 to 5 wt %, more preferably 0.2 to 4 wt %, most preferably 0.5 to 3 wt %, of the weight of the component.

More preferably, at least one of the components used in the method of the present invention comprises at least one surfactant.

Sequestrant

Sequestrants, such as Dequest 2066™ (available from Solutia Inc., St Louis 6366-6760, USA), EDTA, and Dissolvine EDG™ (available from Akzo Nobel, Gillingham, ME7 1RL, UK), aid in stain removal and hence are preferably present in one or more of the components of the method of the present invention, more preferably in the hydrogel-containing component.

The overall level of sequestrant present should be within permitted phosphorus regulations, if relevant. Hence, the upper limit to be used is specific to the particular sequestrant. Thus, for Dequest™ 2066, the amount present is preferably up to 1.5 wt %, more preferably up to 1 wt %, most preferably up to 0.8 wt %, for example 0.8 wt % of the component. Where permitted phosphorus regulations are not relevant, the sequestrant may be present up to 20 wt %, more preferably 15 wt %, of the component. Preferably, the sequestrant is present in any hydrogel-precursor component.

Particularly preferred sequestrants for use with the invention are iminodisuccinic acid or its salts and/or DTPA (diethylene triamine pentaacetic acid).

### GLYCEROL

Glycerol is found to improve the integrity and hence the peelability and thus removability of the patch formed using the method of the present invention, particularly when the glycerol is in the hydrogel-containing component.

Thus, although glycerol is an optional presence in any hydrogel-containing components of the method of the present invention at between 0 and 50 wt %, when present it is preferably found at 2 to 25 wt %, more preferably 4 to 20 wt %, most preferably 6 to 15 wt %, of that component.

The components of the invention are made up to 100 wt % by water, preferably de-ionised water, at levels of 5 to 99 wt % water.

Any or all of the components may further comprise additional cleaning agents, such as monoethanolamine and triethanolamine, at levels in the range 5-20 wt %, more preferably 5-15 wt %, most preferably 5 to 10 wt %, of the respective component.

Any or all of the components may further comprise additional ingredients, such as antimicrobials (e.g. quaternary ammonium compounds, triclosan, and other phenolic agents such as para-chloro meta xylenol (PCMX), citric acid, lactic acid) and if present, are preferably present in the range of 0.01 to 5 wt % of the component, more preferably in the range 0.02 to 3 wt %, e.g. at 1 wt % (especially for triclosan); preservatives, e.g. methylparaben, ethylparaben, propylparaben, or mixtures thereof (if present, preferably present in the range of 0.01 to 0.5 wt % of the component, more preferably in the range 0.01 to 0.2 wt %); or film formers such as polyvinyl alcohol (preferably present in the range of 0-50 wt % of the component where present), polyvinyl alcohol/vinyl acetate copolymers (preferably present in the range of 0-50 wt % of the component where present), and polyvinylpyrrolidone/vinyl acetate copolymers (preferably present in the range of 0-50 wt % of the component where present).

Dyes can also be added to any component to make a coloured patch.

Preferably, in the method of the present invention the user applies a first component to cover all or substantially all of the stain, and then, preferably within 120 seconds, more preferably within 90 seconds, even more preferably within 60 seconds, most preferably within 30 seconds, e.g. as soon as reasonably practical thereafter, applies a second component to cover all or substantially all of the first component, wherein these components are the components described hereinbefore, i.e. preferably a hydrogel-precursor component and a crosslinking component comprising M²⁺ ions. Where a third component is to be added, this is applied to cover all or substantially all of the second component, within similar time periods to those noted above, with the overall application of all components being preferably within 180 secs, more preferably within 120 secs, most preferably within 90 secs.

The components are then left until a removable patch has formed or substantially formed, which can then be removed by the user. Typically the patch takes between 10 secs and 10 mins after application of the final component, and may in certain embodiments, particularly when surfactant is present, be indicated by the formation of a white colour as the patch forms or substantially forms. Thus, preferably, the patch is removed at least 10 secs after application of the final component, more preferably at least 1 min after application of the final component, even more preferably at least 2 mins after application of the final component, yet even more preferably at least 5 mins after application of the final component, most preferably at least 10 mins after application of the final component.

The method of the present aspect of the invention may remove or substantially remove many if not all common stains found on textiles and the like, e.g. oxidisable, such as coffee, tea and wine stains, proteinaceous stains, together with ‘greasy’ stains such as those produced by lipstick and the like, grass stains etc.

Additional, and optional, method steps include the following:
i) applying force to the patch as it is forming;
ii) removing said force once applied;
iii) rubbing the patch as it is forming;
iv) immersing the surface into a wash liquid.

However, the nature of the patch formed by the method of the invention is such that all of the above steps are optional. Therefore a yet further advantage of the method is its simplicity and hence the increased likelihood of user compliance and thus effective treatment of the surface.

According to a further aspect of the present invention there is provided a removable patch comprising a hydrogel-precursor component, and a crosslinking component, both as described hereinbefore, and wherein said patch is obtainable by the method described hereinbefore.

According to a yet further aspect of the present invention there is provided the use of a removable patch comprising a hydrogel-precursor component, and a crosslinking component, both as described hereinbefore, in the treatment of a surface, preferably by the sequential application of said components to said surface.

According to another aspect of the present invention there is provided the use of a removable patch comprising a hydrogel-precursor component, and a crosslinking component, both as described hereinbefore, in the removal of a stain, or part of a stain, from a surface, or a reduction in the amount of said stain, preferably by the sequential application of said components to said surface.

According to another aspect of the present invention there is provided a kit comprising a hydrogel precursor component, and a crosslinking component, both as described hereinbefore.

According to another aspect of the present invention there is provided an applicator means comprising a plurality of separate compartments and wherein each compartment contains at least either a hydrogel-precursor component, and a crosslinking component, both as hereinbefore described, such that said components are kept apart, or substantially kept apart, as and until the components are sequentially applied to a surface to form a removable patch.

According to yet another aspect of the present invention there is provided a method for the treatment of a surface, particularly the treatment of a soft surface, such as for example a textile, comprising the steps of the sequential application to said surface of at least two components as hereinbefore described to form a removable patch on said surface.

According to another aspect of the present invention there is provided a method for the treatment of a surface, particularly the treatment of a soft surface, such as for example a textile, comprising the steps of the sequential application to said surface of at least two components as hereinbefore described to form a patch on said surface.

Finally, according to an aspect of the present invention there is provided the use of a kit comprising a hydrogel-precursor component, and a crosslinking component, both as described hereinbefore, in the treatment of a surface, preferably the removal of a stain, or part of a stain, from a surface, or a reduction in the amount of said stain, preferably by the sequential application of said components to said surface.

By “compartments”, we simply mean a region or container where the particular component is kept until use.

For the avoidance of any doubt, each and every feature described hereinbefore in relation to the first aspect of the present invention is equally applicable to any or all of the other aspects of the present invention, unless such features are incompatible with the particular aspect or mutually exclusive.

The sequential application of the components to the surface can be carried out by any convenient means, for example, by roll-on, spraying (e.g. from an aerosol or pump dispenser), brushing, painting, pouring, rubbing, squeezing etc., but sequential application by spraying or squeezing from a compartment is preferred. Examples of suitable applicator means include any multi-compartment device wherein the components are kept separate from each other as and until application by the user is desired. As such, the separator means can be any substantially non-porous structure. Applicator means should preferably be user-friendly and easily-portable, such as multi-compartment blister packs (with each component in a separate blister), or multi-headed or nibbed applicators (wherein each component is within a separate compartment within the body of the applicator). Moreover, the dispensing element is preferably designed to match the preferred mode of application for the particular component, i.e. brush-type application, spray nozzle, nib-like, roll-on applicator etc.

Preferably, the ratio of the total volume of crosslinking component to the total volume of hydrogel-precursor component employed in the method of the invention is from 1:10 to 10 to 1, more preferably from 1:5 to 5:1, even more preferably from 1:3 to 3:1 and most preferably from 1:2 to 2:1.

When the applicator means is to sequentially apply two components, the applicator comprises two separate compartments. However, when the applicator means is to sequentially apply more than two components, either an equivalent number of separate compartments can be provided or, alternatively, an equivalent number of separate compartments can be provided equal to the number of different components.

Preferably, the compartments of the applicator contain pre-measured amounts of component to ensure application of the preferred amounts of components. Moreover, compartments may be numbered, or otherwise labelled, to ensure the correct order of sequential application of components.

The present invention will now be further illustrated by means of the following non-limiting Examples.

### EXAMPLE 1

Stain Removal Tests

Pre-stained cotton swatches were obtained from Wfk-Cleaning Technology Research Institute, Krefeld, Germany. The swatches were pre-stained with either coffee or red wine.

A hydrogel-precursor component was formed by dispersing Protanal™LF20™ alginate (3 wt %) in glycerol (8 wt %). De-ionized water was then added (in an amount to ensure the wt % figures given herein for the component), followed by sodium lauroyl sarcosinate (4 wt %), and Dequest 2066™ sequestrant (0.75 wt %). This was all performed at room temperature and atmospheric pressure. A crosslinking component (component 1) was formed by mixing CaCl₂.2H₂O (1.1 wt %) in de-ionized water at room temperature and atmospheric pressure.

All wt % figures given above are based on the total weight of the particular respective crosslinking or hydrogel-precursor component.

The components were then applied to the pre-stained swatches in the following sequence: component 1, followed by component 2, followed by component 1. Component 1 was applied via spraying; component 2 was applied by squeezing from a tube or bottle. Approximately 20 secs was left between the application of each component before the next was added. The patch was then left for 10 mins, after which time the presence of the sodium lauroyl sarcosinate surfactant ensured that the patch that had formed appeared a white colour. The patch was then removed manually by peeling.

Table 1 below shows the results of the stain-removal tests, with the removal score assessed by an expert panel being on a scale of 0-10, where 0 represents no visible removal of stain and 10 represents complete removal of stain.

TABLE 1

| Stain on swatch | Removal Score |
|---|---|
| Coffee | 7 |
| Red Wine | 6 |

Moreover, no unpleasant odour was emitted during the test from the patch, swatch or stain, and the swatch remained colour-fast even after patch removal.

Clearly, the method of the present invention was successful in removing/reducing a selection of common stains.

By way of comparison, addition of component 2 alone, i.e. without component 1, led to no patch formation, nor any stain removal. Similar results were found by adding only component 1 to the stain.

### EXAMPLE 2

The following composition was prepared as hydrogel-precursor component.

Hydrogel Component:

| | |
|---|---|
| Protanal ™ LF20 ™ | 3% |
| Glycerol | 8% |
| Dequest ™ 2066 | 0.75% |
| Sodium Lauryl Sulphate | 4% |
| Hydrogen Peroxide | 2% |

pH adjusted to 8 with NaOH solution
Balance to 100% with DI water

The crosslinking component was an aqueous solution of 15% w/w CaCl₂.2H₂O.

Stain removal tests were carried out as detailed for example 1, but in this case the stains had been freshly made on cotton 400 swatches ex Westlairds. In this example, the evaluation scale was as follows:

1 Stain completely removed

2 Halo of stain is visible

3 Stain clearly visible

4 Stain strongly visible

5 As reference

The results were as follows:

| | |
|---|---|
| Red Wine | 2.2 |
| Coffee | 1.9 |
| Mixed red fruit juice | 2.1 |
| Blue ink | 3.0 |
| Tomato | 3.8 |
| Tea | 2.2 |

1. A method for the treatment of a surface comprising the sequential application to the surface of a hydrogel-precursor component and a crosslinking component in either order to form a removable hydrogel patch on said surface, and the removal of the patch once the removable hydrogel patch has formed or substantially formed thereon.

2. A method as claimed in claim 1 wherein the surface is a soft surface.

3. A method as claimed in claim 2 wherein the soft surface is selected from the list consisting of textiles, clothing, carpets, curtains, and upholstery.

4. A method as claimed in claim 1 wherein the surface is a hard surface.

5. A method as claimed in any preceding claim 1 wherein the removal is achieved by peeling said patch from the surface.

6. A method as claimed in claim 1 wherein the removal is via a washing process.

7. A method according to claim 1 wherein the crosslinking component is applied to the surface prior to the application of the hydrogel-precursor component.

8. A method according to claim 7 wherein a second application of the crosslinking component is made after the application of the hydrogel-precursor component.

9. A method as claimed in claim 1 wherein the crosslinking component comprises M²⁺ ions, where M is a Group IIA element or any other metallic element capable of exhibiting a +2 oxidation state, and the hydrogel-precursor component comprises an alginate.

10. A method as claimed in claim 9 wherein the M²⁺ ions are Ca²⁺ ions.

11. A method as claimed in claim 9 wherein the alginate is a sodium alginate.

12. A method as claimed in claim 1 wherein said hydrogel-precursor is present in the range 0.25 to 5 wt % of the weight of the component containing said hydrogel-precursor.

13. A method according to claim 9 wherein the M²⁺ ions are present as 0.03 to 5% by weight of the crosslinking component.

14. A method as claimed in claim 1 wherein at least one of the crosslinking or hydrogel-precursor components further comprises one or more of the following: a bleach, an enzyme and a surfactant.

15. (canceled)

16. A kit comprising a hydrogel-precursor-containing component, and a crosslinking component, both as claimed in claim 1.

17. (canceled)

18. An applicator means comprising a plurality of separate compartments and wherein each compartment contains at least either a hydrogel-precursor component, or a crosslinking component, both as claimed in claim 1, such that said components are kept apart as and until the components are sequentially applied to a surface to form a removable hydrogel patch.
